(19) United States
(12) Patent Application Publication
(10) Pub. No.: US 2015/0112646 A1
(43) Pub. Date: Apr. 23, 2015

(54) METHODS OF DESIGNING THREE DIMENSIONAL (3D) INTEGRATED CIRCUITS (ICs) (3DICs) AND RELATED SYSTEMS AND COMPONENTS

(71) Applicant: QUALCOMM Incorporated, San Diego, CA (US)

(72) Inventors: Pratyush Kamal, San Diego, CA (US); Yang Du, Carlsbad, CA (US); Kambiz Samadi, San Diego, CA (US)

(73) Assignee: QUALCOMM Incorporated, San Diego, CA (US)

(21) Appl. No.: 14/132,377

(22) Filed: Dec. 18, 2013

Related U.S. Application Data
(60) Provisional application No. 61/894,534, filed on Oct. 23, 2013.

(51) Int. Cl. G06F 17/50

(52) U.S. Cl. CPC G06F 17/5081
USPC 703/1

(57) ABSTRACT

Methods of designing three dimensional integrated circuits (3DIC) and related systems and components are disclosed. An exemplary embodiment provides an improved cell library for use with existing place and route software in such a manner that the modified software allows building 3DICs. The improved cell library includes 3D cells that have the footprint of the cell projected onto a two dimensional (2D) image. The projected view may then be discounted to the portion of the cell that is within an upper tier so that the cell appears to the place and route software to be a 2D cell. The discounted 2D image is then used by the place and route software. Such cells allow a circuit designer to leverage the existing 2D place and route tools as well as static timing analysis tools.

### PRIORITY CLAIM

The present application claims priority to U.S. Provisional Patent Application Ser. No. 61/894,534 filed on Oct. 23, 2013 and entitled “METHODS OF DESIGNING THREE DIMENSIONAL (3D) INTEGRATED CIRCUITS (IC) (3DIC) AND RELATED SYSTEMS AND COMPONENTS” which is incorporated herein by reference in its entirety.

### BACKGROUND

I. Field of the Disclosure

The technology of the disclosure relates generally to circuit design and circuit design tools.

II. Background

Mobile communication devices have become common in current society. The prevalence of these mobile devices is driven in part by the many functions that are now enabled on such devices. Demand for such functions increases processing capability requirements and generates a need for more powerful batteries. Within the limited space of the housing of the mobile communication device, batteries compete with the processing circuitry. The limited space contributes pressure to a continued miniaturization of components and constrains power consumption within the circuitry. While miniaturization has been of particular concern in the integrated circuits (ICs) of mobile communication devices, efforts at miniaturization of ICs in other devices have also proceeded.

Historically, elements within an IC have all been placed in a single two dimensional (2D) active layer with elements interconnected through one or more metal layers that are also within the IC. “Place and route” software may be used to optimize placement of elements within such 2D IC. However, even using such place and route software, efforts to miniaturize such ICs with maximized space utilization are reaching their limits in a 2D space and thus, design thoughts have moved to three dimensions. Initially such design thoughts focused on connecting two or more distinct ICs through a separate set of metal layers outside the IC proper. Such external connection has some advantages over prior efforts, but is not properly a three dimensional (3D) approach. A further design evolution was the use of two IC chips that have been stacked one atop another with connections made between the two IC chips through solder bumps (i.e., the so called “flip chip” format). Likewise, there are system in package (SIP) solutions that stack IC chips atop one another with connections made between the chips with through silicon vias (TSVs). While arguably the flip chip and TSV embodiments represent 3D solutions, the amount of space required to effectuate a flip chip remains large. Likewise, the space required to implement a TSV relative to the overall size of the chip becomes space prohibitive.

In response to the difficulties in effectuating small ICs that meet miniaturization goals, the industry has introduced monolithic three dimensional ICs (3DICs). 3DICs offer vertical stacking of devices (including logic circuits) on the same die, with the potential to reduce die area and increase die performance significantly. Currently, the use of 3D logic is limited by the unavailability of true 3D place and route solutions that can place logic cells over one another. That is, as noted above, the industry currently has place and route software that is designed to automate placement of elements within a 2D circuit and route conductors between the elements. The absence of such tools in the 3D context makes for inefficient circuit designs as well as imposing exceptional labor costs as the circuits are designed manually.

### SUMMARY OF THE DISCLOSURE

Embodiments disclosed in the detailed description provide methods of designing three dimensional integrated circuits (3DIC). Related systems and components are also disclosed. An exemplary embodiment includes an improved cell library for use with existing place and route software in such a manner that the modified software allows building three dimensional (3D) integrated circuits (ICs) (3DICs). The improved cell library includes 3D cells that have the footprint of the cell projected onto a two dimensional (2D) image. The projected view may then be discounted to the portion of the cell that is within an upper tier so that the cell appears to the place and route software to be a 2D cell. The discounted 2D image is then used by the place and route software. Such cells allow a circuit designer to leverage the existing 2D place and route tools as well as static timing analysis tools.

In this regard in one embodiment, a non-transitory computer readable medium comprising software with instructions is disclosed. The instructions include instructions to store a library of cells that model elements within an IC. The library of cells contains cells that model at least one 2D cell for placement in an upper tier of a 3DIC. The library also contains cells that model at least one 2D cell for placement in a lower tier of the 3DIC. The library also contains cells that model at least one 3D cell for placement in a plurality of tiers of the 3DIC. The instructions also allow a user to select cells from the library for placement in the 3DIC such that the upper and lower tiers have identical x-y dimensions. The instructions also constrain placement of cells based on potential overlap of bottom tier elements within one or more cells. The instructions also automatically provide a layout of conductive interconnections between placed cells.

In another embodiment, a computing device is disclosed. The computing device comprises a user interface having hardware elements with which a user may physically interact. The computing device also comprises memory elements. The computing device also comprises a control system operatively coupled to the memory elements and the user interface. The control system is configured to store in the memory elements a library of cells that model elements within an IC. The library of cells contains cells that model at least one 2D cell for placement in an upper tier of a 3DIC. The library of cells contains cells that model at least one 2D cell for placement in a lower tier of the 3DIC. The library of cells contains cells that model at least one 3D cell for placement in a plurality of tiers of the 3DIC. The control system is configured to allow a user to select cells from the library for placement in the 3DIC such that the upper and lower tiers have identical x-y dimensions. The control system is configured to constrain placement of cells based on potential overlap of bottom tier elements within one or more cells. The control system is configured to automatically provide a layout of conductive interconnections between placed cells.

In another embodiment, a method of using a computing device loaded with place and route software to design a 3DIC is disclosed. The method comprises storing a library of cells that model elements within an IC in non-transitory memory elements of the computing device. The cells are selected from a group of cells that model at least one 2D cell for placement in an upper tier of the 3DIC, model at least one 2D cell for placement in a lower tier of the 3DIC, and model at least one 3D cell for placement in a plurality of tiers of the 3DIC. The method comprises allowing a user to select cells from the library for placement in the 3DIC. The method comprises constraining dimensions of tiers within the 3DIC such that x-y dimensions of each tier are identical. The method comprises constraining placement of cells based on potential overlap of bottom tier elements within one or more cells. The method comprises automatically providing a layout of conductive interconnections between placed cells.

### BRIEF DESCRIPTION OF THE FIGURES

FIG. 1A is a block diagram of an exemplary three dimensional (3D) integrated circuit (IC) (3DIC) having multiple tiers such as may be designed by exemplary embodiments of the improved cell library for place and route software and methods of the present disclosure;

FIG. 1B is a top down view of a tier of the 3DIC of FIG. 1A with cells and interconnections illustrated;

FIG. 2A is a simplified illustration of a pair of transistors forming a cell for use by an IC;

FIG. 2B is a first multi-tier variant of the cell of FIG. 2A;

FIG. 2C is a top tier variant of the cell of FIG. 2A;

FIG. 2D is a lower tier variant of the cell of FIG. 2A;

FIG. 2E is a variant of the cell of FIG. 2A with selective metal layers available for interconnection of the transistors in the cell;

FIG. 3 is a set of views of the cells of FIGS. 2B-2D in various views;

FIG. 4 is a flow chart showing cell design based on a circuit;

FIG. 5 illustrates a computing device that may use embodiments of the modified cell library with place and route software;

FIG. 6 is a flow chart showing creation of the modified cells for use with the cell library according to an exemplary embodiment of the present disclosure;

FIG. 7 illustrates contrasting placement rules for cells used according to exemplary embodiments of the present disclosure;

FIG. 8 is a flowchart illustrating an exemplary process for using the modified library of the present disclosure to form a 3DIC; and

FIG. 9 is a block diagram of an exemplary processor-based system that can include the 3DIC designed by the processes of the present disclosure.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description provide methods of designing three dimensional integrated circuits (3DIC). Related systems and components are also disclosed. An exemplary embodiment includes an improved cell library for use with existing place and route software in such a manner that the modified software allows building three dimensional (3D) integrated circuits (ICs) (3DICs). The improved cell library includes 3D cells that have the footprint of the cell projected onto a two dimensional (2D) image. The projected view may then be discounted to the portion of the cell that is within an upper tier so that the cell appears to the place and route software to be a 2D cell. The discounted 2D image is then used by the place and route software. Such cells allow a circuit designer to leverage the existing 2D place and route tools as well as static timing analysis tools.

In an exemplary embodiment, the cells within the library may be defined only by the elements of the cell in the top tier. Small cells generally do not require placement of active elements on multiple tiers, and thus, small cells may be merely 2D cells. However, because such small cells may be placed on an upper tier or a lower tier, the library may include such small cells with both upper and lower tier variants. The upper and lower tiers may have similar timing constraints but different footprints. Larger cells may be “folded” such that there is a balance of active elements in upper tiers and lower tiers. Again, the cell, as it appears in the library, is a projection of all the tiers onto a single upper tier.

The reuse of the existing 2D place and route software avoids having to create a whole new software engine and allows circuit design to proceed without having to wait for the new software tool to be developed. The resulting 3DIC will have increased power and performance per unit area compared to traditional 2DIC. To prevent bottom tier overlap, the cells may be defined to have a placement constraint such that other tiers must be spaced so as not to overlap the lower tier elements.

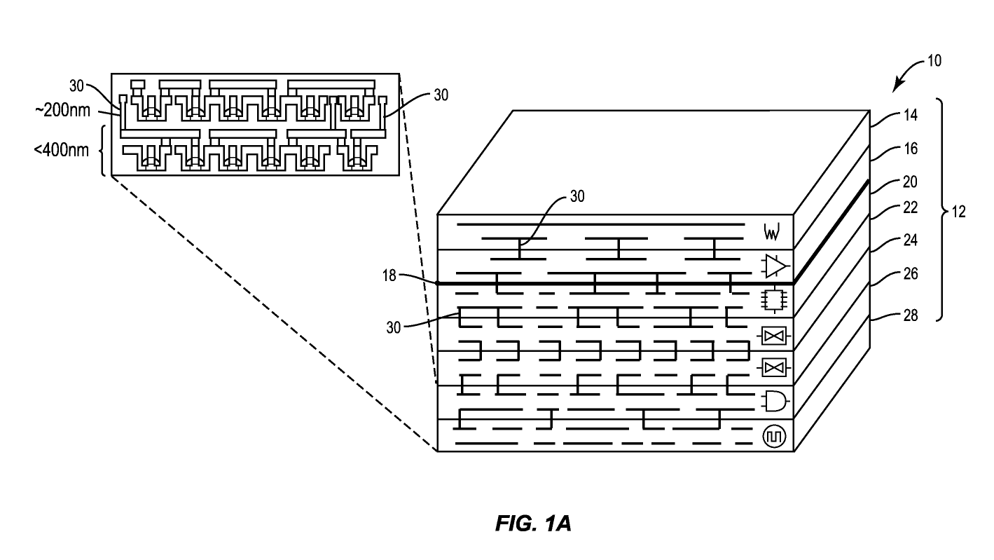

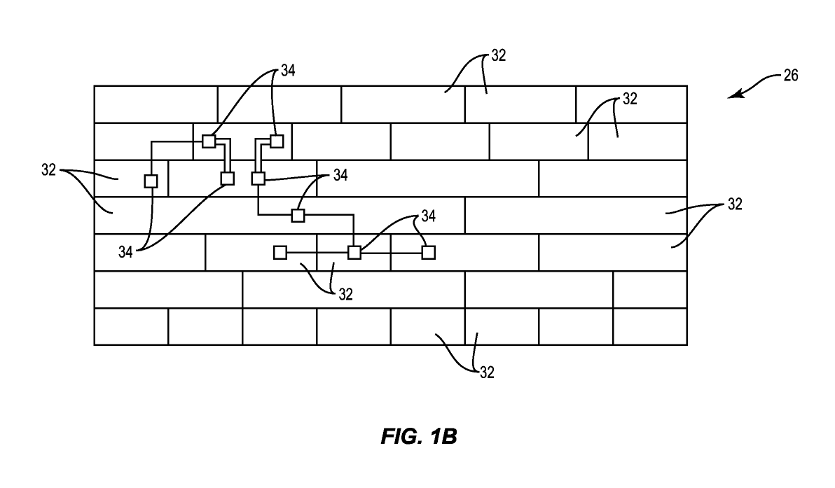

Before addressing exemplary embodiments of the improved cell library for use with place and route software, a brief overview of a 3DIC is provided. In this regard, FIG. 1A is a 3DIC such as may be designed by the processes and systems of the present disclosure. In particular, FIG. 1A illustrates a simplified cross-section of a 3DIC 10. The 3DIC 10 has multiple tiers 12. The tiers 12 may be formed by hydrogen cutting or other monolithic tier formation method. For more information on an exemplary hydrogen cutting process, the interested reader is referred to U.S. patent application Ser. No. 13/765,080, filed Feb. 12, 2013, which is herein incorporated by reference in its entirety.

The use of 3DIC technology allows different tiers of the tiers 12 within the 3DIC 10 to perform different functions and provide all the functions of a particular device in a single 3DIC 10. For example, the 3DIC 10 may be a RF transceiver and controller for a mobile terminal. Thus, a first tier 14 includes sensors and other large feature size elements.

With continued reference to FIG. 1A, a second tier 16 may include radio frequency, analog and/or power management integrated circuit (PMIC) components such as a receiver, transmitter, and duplexer/switch. The second tier 16 may be designed to be relatively low noise so that incoming RF analog signals are not distorted.

With continued reference to FIG. 1A, an electromagnetic (EM) shield 18 may be positioned between the second tier 16 and a third tier 20. The EM shield 18 may be formed from a conductive material such as a graphene layer. For more information about graphene shields in 3DIC, the interested reader is referred to U.S. patent application Ser. No. 13/765,061, filed Feb. 12, 2013, the disclosure of which is herein incorporated by reference in its entirety.

The presence of the EM shield 18 helps prevent noise from the first and second tiers 14, 16 from affecting the low noise characteristics of the third tier 20. The third tier 20 may have a modem or other controller. To accommodate the functions on the third tier 20, the materials and design of the third tier 20 may be selected to promote a medium speed architecture.

With continued reference to FIG. 1A, fourth and fifth tiers 22, 24 may be a memory bitcell array with random access memory (RAM) including dynamic RAM (DRAM), static RAM (SRAM) or the like. Both tiers 22, 24 may be designed to provide low leakage circuitry to improve the operation of the RAM.

With continued reference to FIG. 1A, sixth and seventh tiers 26, 28 may be general processing unit tiers. Sixth tier 26 may include a digital signal processor (DSP) such as a baseband processor using combination logic while seventh tier 28 may include a DSP relying on sequential logic. Both tiers 26, 28 may be designed to support high speeds over concerns about leakage.

In an exemplary embodiment, the tiers are electrically intercoupled by monolithic intertier vias (MIV) 30. For more information about MIV, the interested reader is referred to “High-Density Integration of Functional Modules Using Monolithic 3D-IC Technology” by Shreedpad Panth et al. in the proceedings of the IEEE/ACM Asia South Pacific Design Automation Conference, 2013; pp. 681-686 which is hereby incorporated by reference in its entirety. In contrast to through silicon vias (TSV), MIV may be on the order of sub 100 nm in diameter (i.e., much smaller than the micron dimensions of the TSV) and 200 nm or less depth. Further, in an exemplary embodiment, each of the multiple tiers 12 may be approximately 400 nm thick or thinner. These dimensions are illustrated in the inset of FIG. 1A.

While full system on a chip (SOC) embodiments are possible with 3DIC as illustrated by the 3DIC 10 of FIG. 1A, other smaller IC may also use 3DIC techniques. Such smaller IC may have fewer tiers, but still be 3DIC by having two or more tiers. Within any size 3DIC, there may be components made of one or more transistors such as, for example, a flip-flop, a memory bit cell, a gate, or the like. Such components may be referred to as a cell and may be modeled as a single unit, especially by place and route software.

In this regard, FIG. 1B illustrates a top down view of sixth tier 26 of the 3DIC 10. Sixth tier 26 may include a plurality of cells 32. As noted above, each cell 32 may have one or more logic elements or other conceptual block contained therein. Further, each cell 32 may include one or more contact points 34 (not shown in each cell 32) which may be interconnected to other cells 32 according to the overall circuit design of the 3DIC 10. The interconnections between contact points 34 are effectuated within metal layers (not shown explicitly) within the sixth tier 26. Alternatively, the interconnections may be made (partially or fully) on a different tier (e.g., tiers 14, 16, 20, 22, 24, or 28) in conjunction with MIV 30 to couple horizontal metal portions of the other tier to the contact points 34 within the sixth tier 26. While sixth tier 26 is used for this exemplary discussion, it should be appreciated that other tiers 14, 16, 20, 22, 24, 28 may also have cells, contact points, and interconnections.

It should be appreciated that arranging the cells 32 and interconnections within any IC may be difficult to do manually, especially as the size and/or complexity of the IC increases. The difficulty of this task has given rise to place and route software tools which allow users to select cells from a library and indicate interconnections between selected cells. The software then places the cells within an IC and routes the interconnections in such a manner that there are no improper short circuits or unwanted crosstalk between interconnections. However, to date, these place and route software tools are limited to operation in two dimensions and the library of cells associated with such software are limited to 2D cells. While it is possible to design each tier 12 of 3DIC 10 individually with 2D place and route software, such layering of discrete 2D tiers does not maximize the advantages of the monolithic 3DIC. Accordingly, the efficiencies of place and route software would benefit the design of 3DIC.

Exemplary embodiments of the present disclosure provide methods of designing 3DIC using existing 2D place and route software by adding 3D cells to the cell library of the place and route software. Designers then use the place and route software with the improved library to design circuits.

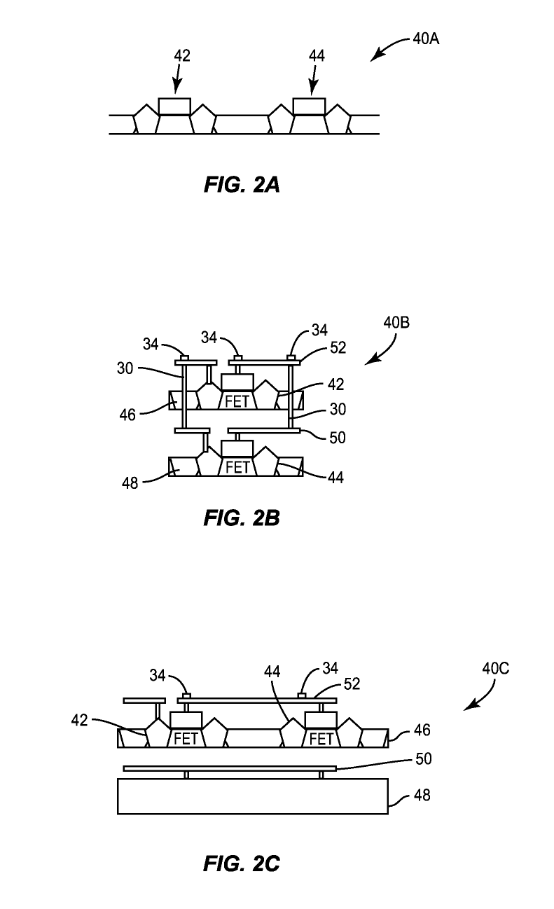

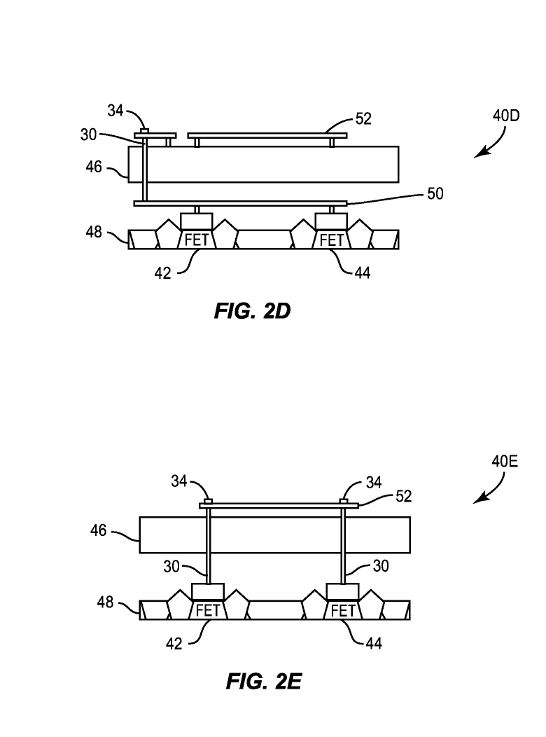

In this regard, exemplary cells that may be modeled and added to a library are illustrated in FIGS. 2A-2E. For example, FIG. 2A illustrates a cell 40A that requires two transistors 42, 44. It should be appreciated that these transistors may be p-type field effect transistors (PFET) or n-type field effect transistors (NFET). The transistors 42, 44 of cell 40B may be positioned on separate tiers 46, 48, as illustrated in FIG. 2B. The transistors 42, 44 may be interconnected by metal layers 50, 52 and MIV 30. The transistors 42, 44 may have contact points 34 on upper tier 46. The MIV 30 may be associated with contact points 34 that provide a contact point for elements in the lower tier 48.

Alternatively, the transistors 42, 44 may be positioned together on an upper tier 46 as illustrated by cell 40C of FIG. 2C. Because there are no elements in the lower tier 48, there are no MIV 30 connecting the lower tier 48 to the upper tier 46. The interconnection between the transistors 42, 44 is through the metal layer 52. Still another placement of the transistors 42, 44 in cell 40D may be on a lower tier 48 as better illustrated in FIG. 2D. The interconnection between transistors 42, 44 may be provided by metal layer 50 as illustrated. MIV 30 couples the transistors 42, 44 to the upper tier 46 where a contact point(s) 34 may be provided.

While the cells 40C and 40D show horizontal interconnections through metal layers 50, 52 in each tier 46, 48, there may be situations where technological constraints dictate that a tier not have metal layers (or may not have enough metal layers to effectuate all the interconnections that tier requires). In such a situation, the cell may have the interconnections in a different tier as illustrated in FIG. 2E.

In this regard, FIG. 2E illustrates cell 40E where both transistors 42, 44 are in lower tier 48, but lower tier 48 does not have metal layer 50 and the transistors 42, 44 are interconnected by metal layer 52 in upper tier 46 with appropriate MIV 30. Contact points 34 are provided in proximity to the MIV 30 so that contact points are available for the elements in the lower tier 48. While not illustrated, it should be appreciated that two transistors positioned in upper tier 46 may be interconnected by metal 50 in lower tier 48 (i.e., the converse of cell 40E).

While only two transistors 42, 44 are illustrated in cells 40A-40E, it should be appreciated that other cells may have more elements and these may be arranged either in both tiers 46, 48 or only in a single tier (e.g., only in upper tier 46 or only in lower tier 48). As is readily understood, the myriad possibilities only exacerbate the difficulty in designing a coherent 3DIC 10.

Exemplary embodiments of the present disclosure propose reusing the 2D placement and routing software with a modified cell library having 2D cells that mimic 3D cells. It should be appreciated that all the original 2D cells are maintained in the cell library. The present disclosure does not propose deletion or elimination of such predefined cells. Rather, exemplary embodiments of the present disclosure allow cells to be added to such libraries either as an add-on module or as needed by designers. However, since the existing place and route software is 2D only, to model 3D cells, the new cells must be modified to work with the 2D place and route software. To make the 3D cells compatible with the 2D place and route software, an exemplary embodiment of the present disclosure provides for a 3D cell to be “projected” into a 2D space to ascertain a footprint of the 3D cell in 2D space. Additionally, the contact points of the cell are specifically provided in the 2D representation. Optionally, the footprint of the projected cell may then be discounted to only include the contact points for the cell.

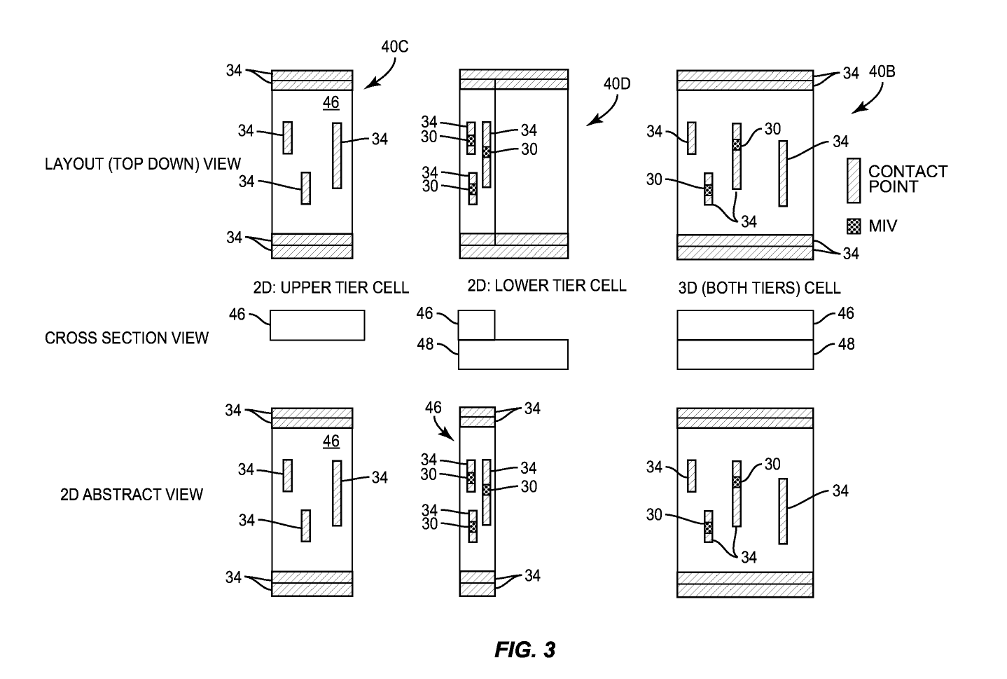

An exemplary graphical illustration of an embodiment of this process is provided in FIG. 3 for the cells 40B-40D of FIGS. 2B-2D. In particular, it is seen that the cell 40B has a top down view that corresponds to the footprint of the cell 40B in both tiers 46, 48. That is, the footprint of the upper tier 46 is co-extensive with the footprint of the lower tier 48 (see cross-sectional view) and thus the 2D abstract view is essentially the same as the 3D top down view with MIV 30 and contact points 34 maintained on the 2D abstract view.

Likewise, the top down view of the cell 40C is essentially the same as the abstract view. In particular, there are no elements on the lower tier 48, so when the information from lower tier 48 is projected into the upper tier 46 (see cross-sectional view), no additional information is added by the projection. The contact points 34 of the elements already present in the upper tier 46 are preserved.

With continuing reference to FIG. 3, cell 40D—which is primarily on the lower tier 48, but whose contact points 34 are in the upper tier 46—is illustrated. As can be seen from the top down view, the elements in the lower tier 48 project into the upper tier 46 to occupy a substantial footprint (at least relative to the elements that are actually in upper tier 46). In contrast, as shown in the 2D abstract view, the contact points 34 only occupy a small portion of the upper tier 46.

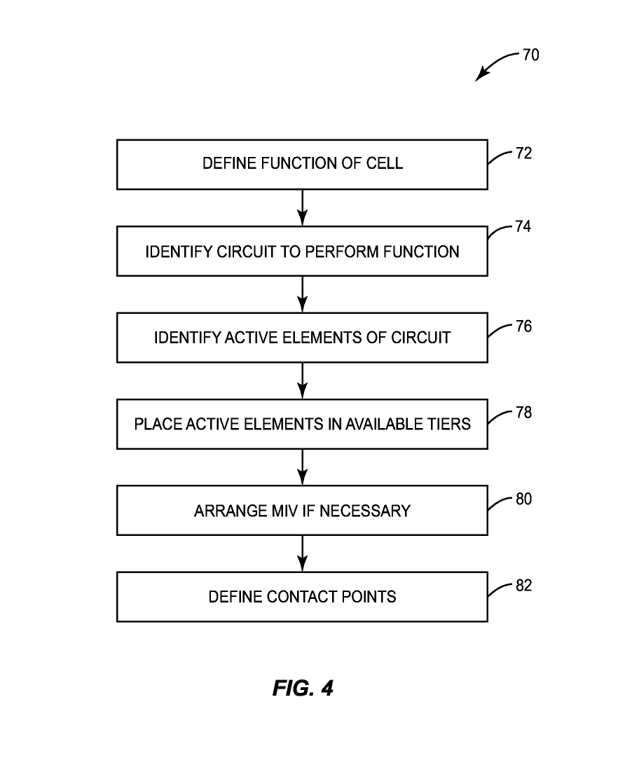

An exemplary method 70 of creating new cells is set forth with reference to the flow chart of FIG. 4. Initially, the designer defines a function for a cell (block 72). This function may be a latch, a memory bit cell, a phase locked loop, a switch, or the like as is well understood. Based on the function, the designer may identify a circuit to perform the function (block 74). The circuit may be well defined or newly created by the designer. From the circuit, the designer may identify the active elements of the circuit (block 76). Additionally, passive elements may likewise be identified if present. The designer may then place the active elements in available tiers (e.g., tiers 46, 48) (block 78). Additionally, passive elements may likewise be placed as desired. The placement may be based on technological constraints, desired footprint, or the like. The designer may then the arrange MIV 30 if necessary (block 80). That is, if elements are present in a lower tier 48 and need to communicate with elements in an upper tier 46, a MIV 30 may be used to effectuate that communication path. The designer may then define contact points 34 (block 82). These contact points 34 may be formed as a function of the elements (e.g., a gate of a transistor) or arbitrarily created as needed or desired.

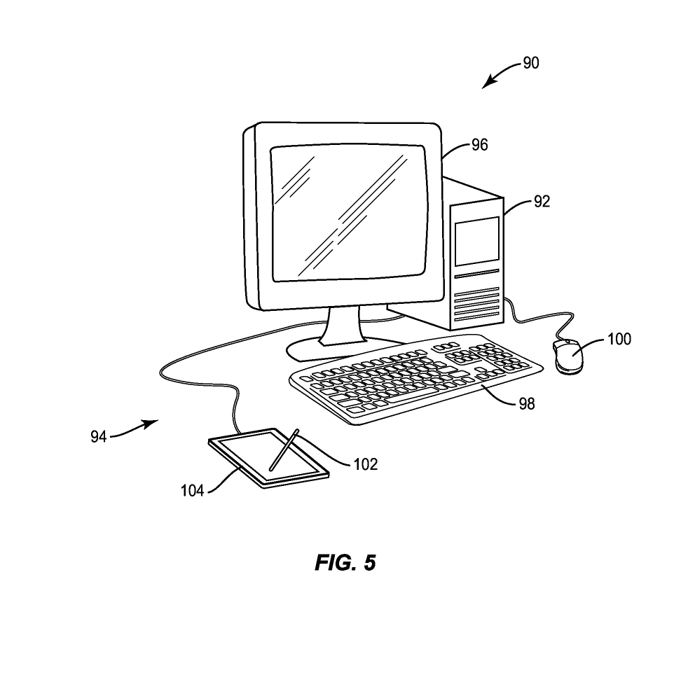

The process 70 may be performed manually or through the assistance of a computing device such as computing device 90 illustrated in FIG. 5. The computing device may include a primary housing 92 with user interface elements 94, which may include a display 96, a keyboard 98, a mouse 100, a stylus 102 with pad 104. While not illustrated, other user interface elements may also be used such as a trackball. The display 96 may be a touch screen display. While shown as a desktop style computing device, it should be appreciated that the design may be performed on a laptop, tablet, or other computing device. While not illustrated, it should be appreciated that the computing device 90 may include a central processing unit (CPU) and non-transitory memory elements such as a hard drive with software stored thereon. As used herein, such CPU is defined to be a “control system.” It should be appreciated that any such control system has a hardware component.

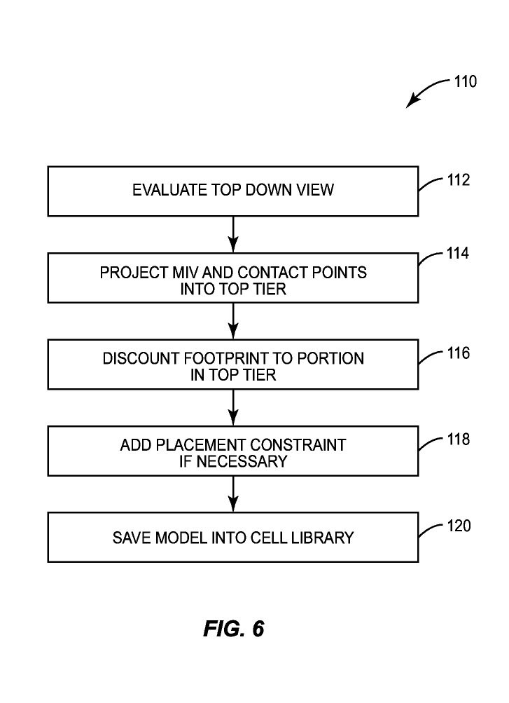

Once the cell is defined, such as through the process 70 of FIG. 4, it may be modeled according to exemplary embodiments of the present disclosure. In this regard, the cell may have a top down view (also referred to as a footprint) and a side view (also referred to as a profile) as illustrated in FIG. 3. The process of modeling the cell is set forth as process 110 with reference to FIG. 6. Process 110 begins with evaluation of the top down view (block 112) to evaluate the overall footprint of the cell. Any MIV 30 and contact points 34 required for the lower tier 48 are projected into the upper tier 46 (block 114). From this projected view, the footprint may be discounted to the portion that exists in the top tier 46 (block 116). In essence, this discount step results in the 2D abstract view of FIG. 3. Thus, for example, cell 40D may be discounted to just the slim strip that has the MIV 30 and the contact points 34 (see FIG. 3).

With continued reference to FIG. 6, the profile is considered and a placement constraint is added (block 118) if needed. Such a placement constraint may be a text string, flag, or similar technique depending on the nature of the place and route software with which the cell being designed will be used.

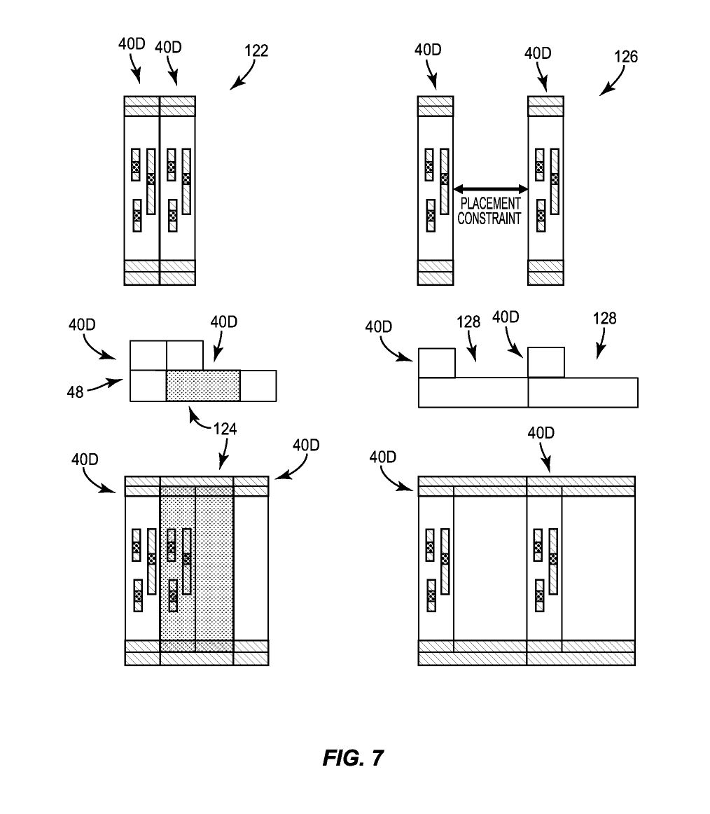

The placement constraint is designed to preclude cells being positioned in the same space. For example, as illustrated in FIG. 7, if there is no placement constraint, cells 40D may be placed right next to each other by place and route software as illustrated by placement 122. Such placement 122 results in overlapping zone 124 where the elements in the bottom tier 48 are put into the same space. Such overlap is unacceptable. In contrast, with a placement constraint that indicates that no cell may be placed adjacent to cell 40D, the placement 126 results. This may result in some unused space 128 in the upper tier 46, but such is considered more acceptable than the overlapping zone 124.

Returning to process 110 of FIG. 6, the cell model with the placement constraint (if present) may then be saved into the cell library (block 120) associated with the place and route software.

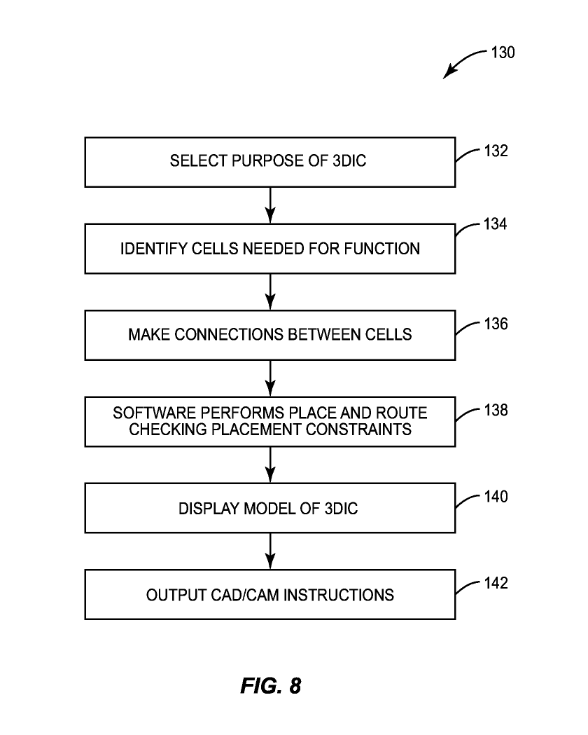

Once the cell library has been supplemented with the 2D versions of the 3D cells to be used, a designer may then begin the process of using the place and route software to design a full 3DIC 10. The process 130 is illustrated in FIG. 8. Initially, the designer selects a purpose for the 3DIC 10 (block 132). For example, the 3DIC 10 could be a transceiver front end, a power amplifier module, a memory device, or the like. The designer identifies cells needed to perform the function (block 134). Thus, if the 3DIC 10 was to be a memory device, memory cells, multiplexers, clocking elements and the like would be identified.

With continued reference to FIG. 8, the designer makes connections between the cells (block 136). Thus, for example, the gate of a first transistor is coupled to a drain of a second transistor. Making these connections is done at a circuit diagram level and does not actually lay out the paths that conductors travel between points to make such connections. Once the circuit is entered into the software, the software may then perform the place and route using the 2D representations of the cells from the cell library (block 138). The software considers any placement constraints as well as any hard macro commands that are associated with any cells used by the designer. It should be appreciated that one of the advantages of a 3DIC such as 3DIC 10 is that the x-y dimensions of the tiers are identical. That is, the plane on which the active elements are placed within a tier may be described as having horizontal x-y coordinates. The thickness (or height or z coordinate) of the tiers may vary, but the x-y dimensions are identical.

With continued reference to FIG. 8, once the software has completed the place and route step the software may display a model of the 3DIC 10 on the display 96 (FIG. 5) (block 140). The displayed model may be at various levels of abstraction as needed or desired. Further, the software may output computer aided design/computer aided manufacture (CAD/CAM) instructions to facilitate fabrication of the 3DIC 10 (block 142).

The 3DIC 10 designed with placement and routing software with a modified cell library according to embodiments disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

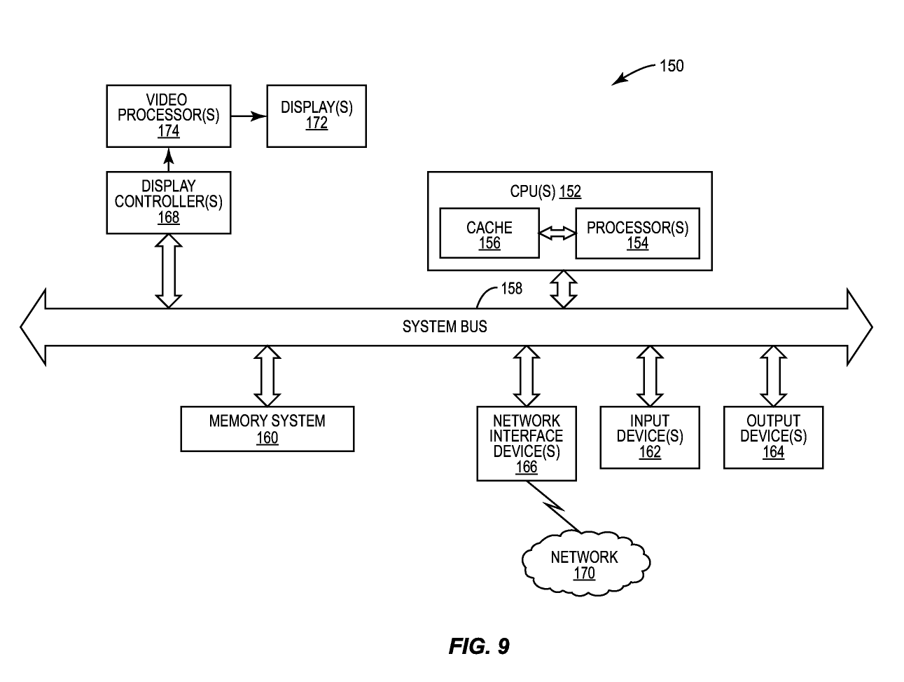

In this regard, FIG. 9 illustrates an example of a processor-based system 150 that can employ the 3DIC 110 illustrated in FIG. 1. In this example, the processor-based system 150 includes one or more central processing units (CPUs) 152, each including one or more processors 154. The CPU(s) 152 may have cache memory 156 coupled to the processor(s) 154 for rapid access to temporarily stored data. The CPU(s) 152 is coupled to a system bus 158 and can intercouple master devices and slave devices included in the processor-based system 150. As is well known, the CPU(s) 152 communicates with these other devices by exchanging address, control, and data information over the system bus 158. Although not illustrated in FIG. 9, multiple system buses 158 could be provided, wherein each system bus 158 constitutes a different fabric.

Other master and slave devices can be connected to the system bus 158. As illustrated in FIG. 9, these devices can include a memory system 160, one or more input devices 162, one or more output devices 164, one or more network interface devices 166, and one or more display controllers 168, as examples. The input device(s) 162 can include any type of input device, including but not limited to input keys, switches, voice processors, etc. The output device(s) 164 can include any type of output device, including but not limited to audio, video, other visual indicators, etc. The network interface device(s) 166 can be any devices configured to allow exchange of data to and from a network 170. The network 170 can be any type of network, including but not limited to a wired or wireless network, private or public network, a local area network (LAN), a wide local area network (WLAN), and the Internet. The network interface device(s) 166 can be configured to support any type of communication protocol desired.

The CPU(s) 152 may also be configured to access the display controller(s) 168 over the system bus 158 to control information sent to one or more displays 172. The display controller(s) 168 sends information to the display(s) 172 to be displayed via one or more video processors 174, which process the information to be displayed into a format suitable for the display(s) 172. The display(s) 172 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The arbiters, master devices, and slave devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A non-transitory computer readable medium comprising software with instructions to:
store a library of cells that model elements within an integrated circuit (IC), the library of cells containing cells that:
model at least one two dimensional (2D) cell for placement in an upper tier of a three dimensional (3D) IC (3DIC);
model at least one 2D cell for placement in a lower tier of the 3DIC; and
model at least one 3D cell for placement in a plurality of tiers of the 3DIC;
allow a user to select cells from the library for placement in the 3DIC such that the upper and lower tiers have identical x-y dimensions;
constrain placement of cells based on potential overlap of bottom tier elements within one or more cells; and
automatically provide a layout of conductive interconnections between placed cells.

2. The non-transitory computer readable medium of claim 1, wherein the software with instructions has further instructions to automatically place one or more cells selected by the user.

3. The non-transitory computer readable medium of claim 1, wherein the software further exports computer aided manufacturing instructions for manufacturing of a 3DIC modeled by the software.

4. The non-transitory computer readable medium of claim 1, wherein the software further has instructions to provide a completed 3DIC model on a display to the user.

5. The non-transitory computer readable medium of claim 1, wherein the instructions to allow the user to select cells from the library for placement in the 3DIC comprise instructions that interoperate with input elements selected from the group consisting of: a mouse, a stylus, a display, a keyboard, a trackball, and a touch screen.

6. The non-transitory computer readable medium of claim 1, wherein the instructions to store a library of cells that model the at least one 3D cell for placement in the plurality of tiers of the 3DIC comprise a model of a 3D cell having active elements on the upper tier and additional active elements on the lower tier.

7. The non-transitory computer readable medium of claim 1, wherein the x-y dimensions define a horizontal plane.

8. A computing device, comprising:
a user interface having hardware elements with which a user may physically interact;
memory elements;
a control system operatively coupled to the memory elements and the user interface, the control system configured to:
store in the memory elements a library of cells that model elements within an integrated circuit (IC), the library of cells containing cells that:
model at least one two dimensional (2D) cell for placement in an upper tier of a three dimensional (3D) IC (3DIC);
model at least one 2D cell for placement in a lower tier of the 3DIC; and
model at least one 3D cell for placement in a plurality of tiers of the 3DIC;
allow a user to select cells from the library for placement in the 3DIC such that the upper and lower tiers have identical x-y dimensions;
constrain placement of cells based on potential overlap of bottom tier elements within one or more cells; and
automatically provide a layout of conductive interconnections between placed cells.

9. The computing device of claim 8, wherein the user interface comprises at least one of a mouse, a display, a stylus, keyboard, a touch screen, and a trackball.

10. The computing device of claim 8, wherein the control system is further configured to automatically place one or more cells selected by the user.

11. The computing device of claim 8, wherein the control system is further configured to export computer aided manufacturing instructions for manufacturing of a 3DIC modeled by the control system.

12. The computing device of claim 8, wherein the x-y dimensions define a horizontal plane.

13. The computing device of claim 8, wherein the control system is further configured to provide a completed 3DIC model on a display within the user interface.

14. A method of using a computing device loaded with place and route software to design a three dimensional (3D) integrated circuit (IC) (3DIC), comprising:
storing a library of cells that model elements within an IC in non-transitory memory elements of the computing device, wherein cells are selected from a group of cells that:
model at least one two dimensional (2D) cell for placement in an upper tier of the 3DIC;
model at least one 2D cell for placement in a lower tier of the 3DIC;
model at least one 3D cell for placement in a plurality of tiers of the 3DIC;
allowing a user to select cells from the library for placement in the 3DIC;
constraining dimensions of tiers within the 3DIC such that x-y dimensions of each tier are identical;
constraining placement of cells based on potential overlap of bottom tier elements within one or more cells;
automatically providing a layout of conductive interconnections between placed cells.

15. The method of claim 14, further comprising automatically placing one or more cells selected by the user.

16. The method of claim 14, further comprising exporting computer aided manufacturing instructions for manufacturing of a 3DIC modeled by the place and route software.

17. The method of claim 14, further comprising allowing input from the user through one of a mouse, a stylus, a keyboard, a trackball, and a touch screen.

18. The method of claim 14, further comprising allowing users to define new cells for the library.

19. The method of claim 14, wherein the x-y dimensions define a horizontal plane.

20. The method of claim 14, further comprising presenting on a display a completed 3DIC model.

21. The method of claim 14, further comprising creating a placement constraint on the cell that models at least one 2D cell for placement in the lower tier of the 3DIC.

22. The method of claim 14, further comprising routing between cells using metal layers associated with the upper tier.
